(19) United States
(12) Patent Application Publication
(10) Pub. No.: US 2007/0182543 A1
(43) Pub. Date: Aug. 9, 2007

(54) Intelligent Home Security System

(76) Inventor: Hongyue Luo, Waterloo (CA)

Correspondence Address: HONGYUE LUO, 216 TATLOCK CRT, WATERLOO, ON, N2L-5Y6, CA

(21) Appl. No.: 11/307,417

(22) Filed: Feb. 6, 2006

(30) Foreign Application Priority Data
Feb. 4, 2006 (CA) 00000000001

(51) Int. Cl. G08B 19/00; G08B 13/00

(52) U.S. Cl. 340/521; 340/541

(57) ABSTRACT

The present invention relates an intelligent home security system and method for protecting homes by detecting an approach, intelligently making decision for active responses, alarming and contacting the respective person or organization through communication link. With the associated hardware by applying psychological knowledge and human intelligence, the intelligent home security system and method can significantly reduce the possibility of an intruder breaking-in or even prevent a breaking-in from happening by real-life simulating, reactive real-life simulating, active and intelligent responding; help to identify and track intruders by taking photos at the suitable time, which offers valuable information for crime investigation and eventually reduces the crime rate, in addition to the conventional intruder detection, alarming and reporting to a security monitoring center or the respective person

### FIELD OF THE INVENTION

This invention relates to an intelligent home security system and method for residential houses or small business offices. More particularly, this invention relates to an intelligent home security system and method with the associated hardware by applying psychological knowledge and human intelligence for real-life simulating, reactive real-life simulating, active responding with human intelligence, smart photo taking for possible trace analysis, alarming and automatically reporting event to respective person or organization.

### BACKGROUND OF THE INVENTION

The conventional home security systems in use today typically includes intrusion detection, smoke/fire detection, carbon monoxide (CO) detection, remote control, alarm and reporting event through an available communication link such as telephone line. More specifically, the home security system usually detects intruder broken-in through various alarm components or sensors such as door/window contact sensors or infrared sensors, and it will alarm once an illegal access happens, and it will further communicates an alarm signal to a security monitoring center or the respective person.

Various approaches have been made for improving security systems. For example, U.S. Pat. No. 5,543,778 teaches a home security system that includes a plurality of alarm elements; a central console including a microprocessor in wireless communication with the alarm elements and effective to receive a signal from the alarm elements; an automobile including an alarm system in wireless communication with the central console's microprocessor and effective to activate certain alarm elements when the automobile's alarm system is in close proximity to the home security system and when the automobile is started. This invention provides a security system having various security components to communicate to a central console in a wireless manner, which overcomes the difficulties and reduces the cost to install the home security system since each of the separate components can be easily connected to the central console without wire.

U.S. Pat. No. 6,759,957 discloses a home security system which includes sensors that detect an alarming situation in different locations inside a facility, cameras that capture images of different locations inside a facility, and a controller that memorizes the associations between sensors and camera, and when any of the sensors detects an alarming situation, has cameras that are associated with the sensors that have detected an alarming situation capture images based on the associations, and also updates the memorized associations.

All home security systems in markets share the same or similar principle: protect the home from intruder by monitoring the home, alarming and/or reporting the intruder to the security monitoring center or the respective person once an intrusion is detected. On the other hand, it also protects resident life safety and house safety from CO, gas, fire or smoke.

As it is well known, an intruder generally looks for two elements before selecting a home as the target to break-in. These two elements are: ability to get in and out quickly, and the ability to remain unseen. Therefore, they usually avoid to approach a well protected home or an occupied home. This is the reason why it is important to use security locks for doors and windows, and keeping the property well lit at night with interior lighting and/or outdoor lighting. A timer for interior lighting can make an impression that the home is occupied, and the motion detection with outdoor lighting can startle the intruders when they approach the home.

However, all home security systems in markets today are passive systems and they cannot react to a potential intruder intelligently and pre-emptively before intruder starts to break-in. For the skilled intruders, they can approach a home and find out whether the home is actually occupied by pretending, for example, a sales person, mail deliverer or local social worker. They may knock door or push door bell first. Once they find no response from the inside, they may try to get in. Once the event such as burglar has happened, the home security system will be able to detect it and then contact the associated organization such as a security monitoring center and/or the respective person. Usually, it will take about 3 minutes or longer for a fast response if the home security system detects an intruder breaking-in and contacts a security monitoring center. During this period of time, the damage of the home such as door or window usually has been made, valuable things may have been stolen, and other damage could also have happened before police or security person arrives. It is also well known that many homes have never installed a home security system or have not activated the security monitoring service because of high service cost.

The conventional home security system in use today also cannot take and keep the crime trace which can be captured before or during the intruder's breaking-in. Most conventional home security systems can only alarm and report the already happened broken-in, which usually is too late to prevent a breaking-in from happening. Usually, it is also very difficult to catch an intruder even a home security system has already detected and reported to the security monitoring center. It is reported that the rate for the police to identify an intruder and, finally, catch him/her has been very low, because of not enough police force or not enough crime trace or clue to use for the crime investigation.

### SUMMARY OF THE INVENTION

The object of the present invention is to provide an intelligent home security system and method by applying psychological knowledge and human intelligence to the system that can significantly reduce the possibility of an intruder breaking-in or even prevent a breaking-in from happening by real-life simulating, reactive real-life simulating, active and intelligent responding; help to identify and track intruders by taking photos at the best time such as before or during breaking-in, which offers valuable information for crime investigation and eventually reduces the crime rate, in addition to the conventional intruder detection, alarming and reporting to a security monitoring center or the respective person.

The present invention provides an active intelligent home security system comprising: a) security detection for detecting an approach in different alert levels; b) safety detection for detecting physical safety of the home for the residents and home; c) intelligent system processor for handling both security detection and safety detection, and for all the necessary intelligent responses; d) action device for various simulating, alarming and active responses; e) camera for taking photo or video monitoring purposes; f) communication link for alarm or warn purpose and/or reporting the detected events; and g) remote controllers for arming, disarming and other control purposes.

In the focus of the security system, the present invention provides an active intelligent home security system comprising: a) one or multiple motion sensors for detecting an approach to the surrounding property area; b) one or multiple entrance sensors such as infrared sensors for detecting an entrance to the security control area; c) one or multiple door/window contact sensors or infrared sensors for detecting unauthorized access; d) one or multiple action devices such as indoor lights, outdoor lights, speaker, siren, or other controllable device for real-life simulating or active responses; e) an intelligent information processor for real-life simulating, reactive real-life simulating, active responding with human intelligence, and smart photo taking for crime trace analysis; f) one or multiple cameras for video monitoring and photo taking; g) a communication link so that it can send alarm or warning information to the respective person or organization such as security monitoring center; and, h) remote controllers for arming the system, disarming the system or other control purposes.

### BRIEF DESCRIPTION OF THE DRAWINGS

For a better understanding of the present invention and to show more clearly how it may be carried out into effect, reference will now be made, by way of example only, to the accompanying drawings which show preferred embodiments of the present invention and in which:

FIG. 1 is an overall structure of the intelligent home security system 10 with security detection 20, safety detection 30, intelligent system processor 40, action devices 50, camera 60, communication link 70 and remote controllers 80. All elements in the system can be connected as required either through wire or wireless link.

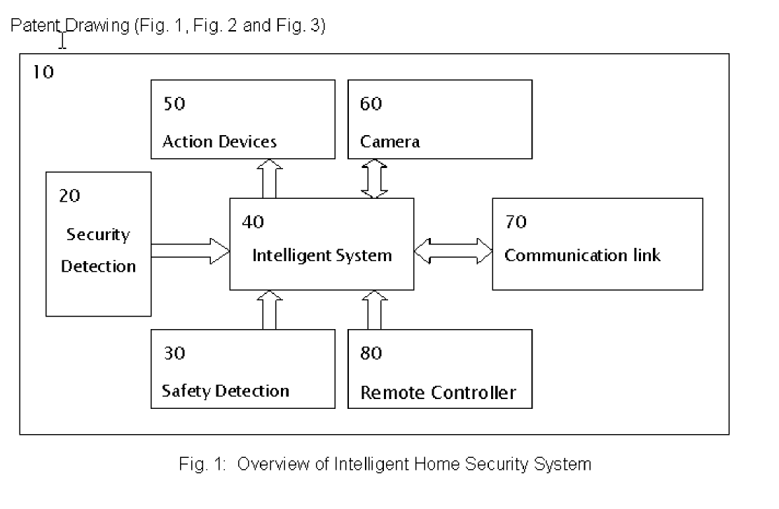

FIG. 2 is a typical schematic block diagram of the intelligent home security system 10. The security detection 20 comprises one or multiple motion sensors 22, one or multiple infrared access sensors 24, and door/window access sensors 26 and 28. The safety detection 30 comprises one or multiple fire/smoke sensors 32, CO sensors 34 or other sensors. The intelligent information processor 40 comprises system processor 42, control panel 44 and system memory 46. The action device 50 comprises one or multiple indoor lights 52, outdoor lights 54, and speaker 56 for playing pre-recorded sound or alarm. The camera 60 comprises one or multiple digital cameras, web cameras or video cameras for photo taking or video monitoring. The communication link 70 comprises one or multiple means such as telephone 72, internet 74, wireless 76, computer 78 or other communication devices. The remote controller 80 may include one or multiple units for all the member of the family.

FIG. 3 is a typical set up of the intelligent home security system in a typical home. Three areas of the residential home or small office are defined as the property area 90, the security control area 92 with main entrance and the home area 94. The motion sensor or sensors 22 are set up to monitor an approach to the property area 90 for providing a primary input signal to the system processor 40 for reactive real-life simulating. The outdoor lighting 54 is set up in such a way that it can make the entrance clear for walking and prepare for the suitable light so that the camera 60 can take a clear photo. The indoor lighting 52 and the speaker 54 are set up in such a way that they can be used for normal daily life use or as a part of the intelligent home security system. One or multiple entrance sensors 24 such as infrared sensors are set up to detect the entrance to the security control area 92 for providing an entrance input signal to the system processor 40 for active responding and active intelligent responding. The camera 60 is set up in such a way that it locates inside the house but can take photo at the corresponding position for clear picture with the suitable light. One or multiple door/window contact sensors or infrared sensors 26/28 are set up to detect an unauthorized intrusion to the home area 94 for providing an illegal intrusion input signal to the system processor 40. The end user may choose to set up any one area, any two areas or the combination of all three areas for the intelligent home security system.

### DETAILED DESCRIPTION OF THE PREFERRED EMBODIMENTS

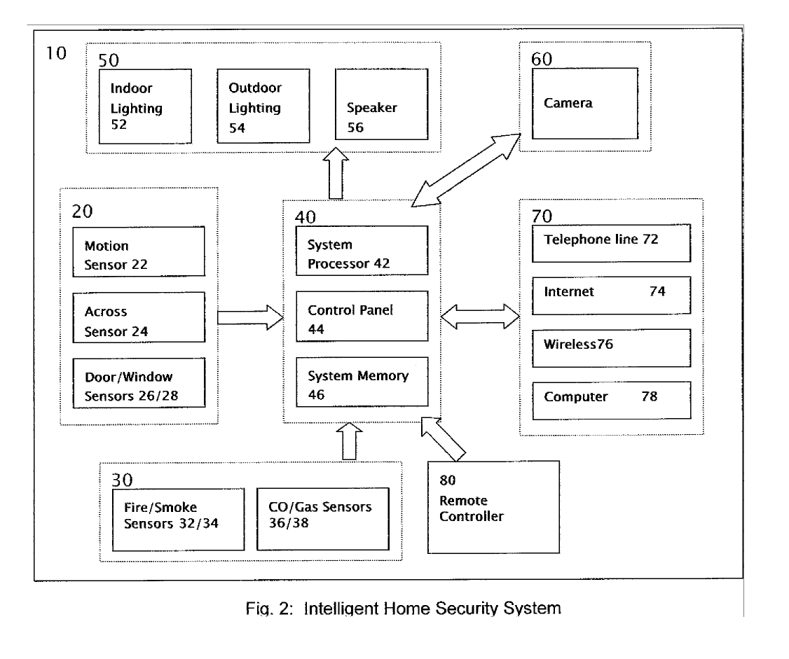

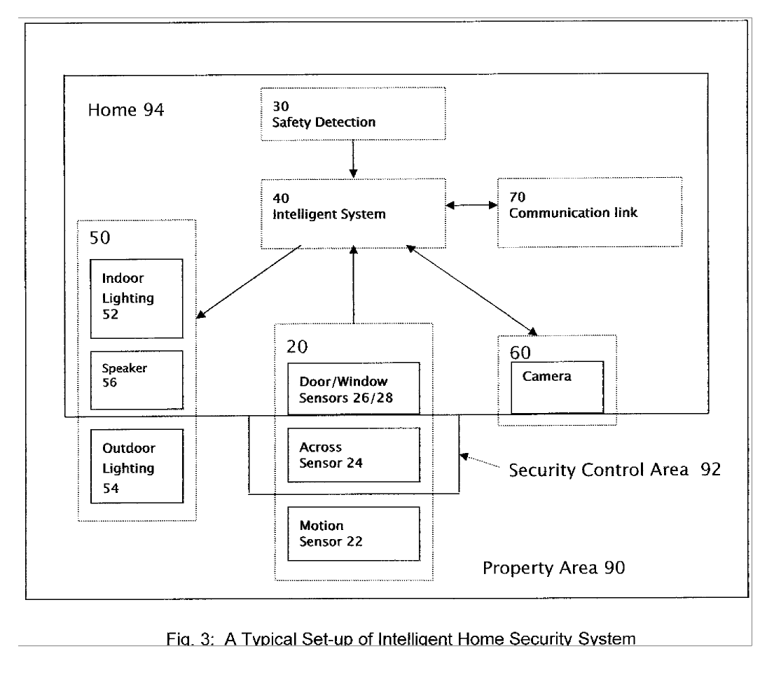

Referring to FIG. 2 and FIG. 3, the motion sensor 22 provides an approach signal to the property area for the system processor 40, which is used as the primary approach input for the intelligent home security system 10, and the infrared sensor 24 provides an entrance signal to the security control area for the system processor 40, which is used as the entrance signal for the intelligent home security system 10. The door/window access sensors 26 and 28 provide an unauthorized intrusion signal to the home area for the system processor 40, which is used as the intrusion input for the intelligent home security system 10. These sensors can be enabled or disabled accordingly depending on whether the intelligent home security system 10 is fully armed, partial armed or fully disarmed. The system processor 40 processes all sensors' signals for controlling interior lighting 52, outdoor lighting 54, speaker 56 to play back the pre-recorded sound such as family conversation, scene sensitive conversation, warn message or alarm. The system processor 40 can automatically and adaptively process different sensor inputs for an intelligent and adaptive action to different alert levels of approach. According to the pre-defined program, the intelligent system processor 40 can control the camera 60 to take a photo or photos at different alert levels of approach, and decide to update photos, save the photos or transmit the photos to the respective persons or organization. Once an intruder or burglar is detected by the door/window access sensors 26/28, the intelligent system processor 40 will alarm, warn, and/or report the intruder to the respective person or organization through the communication link 70 such as telephone 72, internet 74, wireless 76 or computer 78. For the safety detection, the safety sensors 30 such as fire/some 32/34 or OC/Gas 36/38 also have inputs to the intelligent system processor 40 and once any of the safety sensors detects an event, the intelligent system processor will react accordingly either by alarming or reporting to the respective person or organization. In all individual situations, the system processor 40 will record the event and the time associated with the event for investigation or safety pattern recognition. The intelligent home security system 10 can be fully armed, partial armed or fully disarmed through the remote controller or the system control panel according to the need and requirement of the user.

In a first embodiment, the present invention provides a system and method of operating an intelligent home security system as real-life simulating: a) according to the pre-defined time pattern, random pattern or self-learning family life pattern to play some sound such as music or conversation through speaker, turn some lights on or off. This usually will make people feel that the home is occupied so that some intruders will select not to approach the home.

In another embodiment, the present invention provides a system and method of operating an intelligent home security system as reactive real-life simulating with or without including the real-life simulating: a) sensing an approach to the property area by a motion sensor and providing an input signal to the system processor; b) the system processor plays back some pre-recorded family conversations and turns some lights on or off to let the suspect feel that the home is occupied; since the home security system reacts to the approach, which the timer cannot do, this usually will stop some skilled burglars to make further approach to the home, which therefore will reduce crimes; c) the system processor can control the camera to take a photo as the awareness so that the home owner will know who is coming if they are inside. In this way, the camera is working as an audio monitoring system for home monitoring, but the photo is only for display purpose and it is not necessary saved. The camera can take photos with different time interval so that the home owner can see the updated photos inside for home monitoring purpose. These photos can be refreshed according to the preference or updated according to the internal memory size.

In another embodiment, the present invention provides a system and method of operating an intelligent home security system as active responding with or without including the real-life simulating or the reactive real-life simulating: a) sensing an approach to the security control area by an entrance sensor such as infrared sensor and providing an input signal to the system processor; b) the system processor plays back some pre-recorded scene sensitive family conversations such as “Dad, somebody is coming” and then “We are very busy now and please call back later”. This kind of scene sensitive conversation can drive many intruders including those skilled ones away since they will not select the occupied home or afraid of being seen. This usually will stop some skilled burglars to make further approach to the home, which therefore will reduce crimes; c) taking a photo and saving it, and/or saving previous taken photos, once no confirmation of the pre-authorized approach is identified, which is the best time to take photo and save it before the intruder starts to break-in the home. The taken photos can be used either for the crime investigation if a burglar happens or for identifying the friend visiting when the home owner is on vacation.

In another embodiment, the present invention provides a system and method of operating an intelligent home security system as active intelligent system with or without including the real-life simulating or reactive real-life simulating: a) sensing an approach to the security control area by an entrance sensor such as infrared sensor and providing an input signal to the system processor; b) the system processor plays back some pre-recorded scene sensitive family conversations such as “Dad, somebody is coming” and then “We are very busy now and please call back later”. This kind of scene sensitive conversation can drive many intruders including those skilled ones away since they will not select the occupied home or afraid of being seen. This usually will stop some skilled burglars to make further approach to the home, which therefore will reduce crimes; c) taking a photo and saving it, and/or saving previous taken photos, once no confirmation of the pre-authorized approach is identified, which is the best time to take photo and save it before the intruder s break-in the home. The taken photos can be used either for the crime investigation if a burglar happens or for identifying the friend visiting when the home owner is on vacation; d) sensing an unauthorized access through door/window contact sensors or infrared sensor and providing an input signal to the system processor; e) the system processor trigs acoustic alarm through speaker or siren, transmits the photo and send alarm notice to the security monitoring center or the respective person through the available communication link. The photos of the suspected intruders with timing information can be extremely useful for the crime trace analysis and crime investigation.

The intelligent home security system may include the part of elements or all elements as real-life simulating, reactive real-life simulating, active responding, or active intelligent system. It should be understood that various modifications can be made to the preferred embodiments described and illustrated herein, without departing from the present invention, the scope of which is defined in the appended claims.

What is claimed is:

1. An Intelligent Home Security System comprising: a). security detection; b). safety detection; c). intelligent system processor; d). action devices; e). digital camera; f). communication device or link; and/or g ). remote controller.

2. A residential home or office is divided into three areas for intelligent home security monitoring comprising: a). property area which includes the major residential area for the primary approach detection; b). security control area which includes the major entrances for the entrance detection; c). home area which includes the inside of the whole building for the illegal access detection and safety detection.

3. The Intelligent Home Security System according to claim 1 and claim 2, wherein: a). one or multiple motion sensors for sensing a primary approach to the property area and providing a primary approach input signal; b). one or multiple infrared sensors for sensing an entrance to the security control area and providing an entrance input signal; c). one or multiple door/window sensors for sensing a breaking-in and providing intruder input signal for alarm purpose, indicating that the broken-in has happened; d). a system processor that can process all individual inputs and taking a proper action accordingly and controlling outdoor lighting, indoor lighting, speakers, camera or the available communication device; e). outdoor lights, indoor lights, speakers; f). one or multiple cameras for taking photo or audio monitoring device; g). communication device or link such as telephone, internet, wireless or other available communication devices; h). remote controllers for arming and disarming the system or other control purposes; and, i). all the above elements are connected according to their functionality either by wire or wireless.

4. The Intelligent Home Security System of claim 3, wherein the system processor plays music, radio or pre-recorded speech through speaker, turn some lights on or off, according to the pre-defined time pattern, random pattern or self-learning family live pattern to work as real-life simulating system. In this system mode, a), b) or c) of claim 3 may or may not exist in the intelligent home security system.

5. The Intelligent Home Security System of claim 3, wherein the motion sensor detects a primary approach to the property area by providing an input signal to the system processor, and an intelligent home security system works as reactive real-life simulating system. In this system mode, b) or c) of claim 3 may or may not exist in the intelligent home security system.

6. The Intelligent Home Security System of claim 3, wherein the infrared sensor detects an entrance to the security control area by providing an input signal to the system processor and an intelligent home security system works as active responding system. In this system mode, a) or c) of claim 3 may or may not exist in the intelligent home security system.

7. The Intelligent Home Security System of claim 6, wherein one or multiple door/window access sensors detect an unauthorized intrusion such as breaking-in to the home by providing an input signal to the system processor; the system processor starts warn message or siren alarm; and reports to the security monitoring center or the respective person for an intelligent home security system as active intelligent system. In this system mode, a) of claim 3 may or may not exist in the intelligent home security system.

8. The intelligent home security system of claim 3 can be fully armed, partially armed, or fully disarmed by the user through remote controller or the system control panel for the preferable working mode according to the requirement.

9. An efficient and low cost intelligent home security system of claim 3 with applying psychological knowledge and human intelligence for home or office with or without associating with a security monitoring center.

10. A method of operating an Intelligent Home Security System of claim 4 according to the timing, pre-defined pattern or randomly turn on/off some indoor lighting, outdoor lighting to act as real-life simulating.

11. A method of operating an Intelligent Home Security System of claim 5, wherein sensing a primary approach to the property area and providing an initial approach input signal to the system processor, and the system processor will control the outdoor lighting, indoor lighting, or speaker to act as reactive real-life simulating.

12. A method of operating an Intelligent Home Security System of claim 6, wherein sensing an entrance to the security control area and providing entrance input signal to the system processor, and the system processor will control the speaker to play pre-recorded scene sensitive conversation, taking photos for audio monitoring purpose or saved for trace analysis and clue information to act as active responding; The home owner or the authorized person can remote control the intelligent home security system to not react to the authorized entrance.

13. A method of operating an Intelligent Home Security System of claim 12, wherein sensing an actual intrusion to the home and providing broken-in input signal to the system processor, and the system processor will take photos, trig alarm and report to the security monitoring center or the respective person by sending alarm signal or photo, and saving all taken photos for crime trace analysis and crime investigation as active intelligent system.

14. A method for efficient and low cost intelligent home security system of claim 3 with applying psychological knowledge and human intelligence for home or office with or without associating with a security monitoring center.
